(19) United States
(12) Patent Application Publication
(10) Pub. No.: US 2010/0083159 A1
(43) Pub. Date: Apr. 1, 2010

(54) SEGMENTED PROGRESS INDICATOR

(76) Inventor: Dale Llewelyn Mountain, Silsden (GB)

Correspondence Address: DORSEY & WHITNEY LLP;on behalf of EchoStar Technologies, L.L.C., 370 Seventeenth St., Suite 4700, Denver, CO, 80202-5647, US

(21) Appl. No.: 12/242,286

(22) Filed: Sep. 30, 2008

(51) Int. Cl. G06F 3/048

(52) U.S. Cl. 715/772

(57) ABSTRACT

A segmented progress bar is displayed for an operation including at least two steps. A segmented progress indicator displays a separate section for each step indicating the progress of the step. The display of the progress of each section is displayed at an approximately constant rate. Thus, the segmented progress indicator may not appear erratic and/or random. The percentage of work performed for a step is determined and represented in the respective section as the percentage filled. An error in one or more steps may be indicated in the respective section. The progress of individual steps included in an operation may be displayed in a linear sequence, a non-linear sequence, and/or a mixture of linear sequences and non-linear sequences. The sections of a segmented progress indicator may have similar dimensions or dissimilar dimensions with a relationship between the dimensions which is proportional to the times (or estimated times) for completion.

### FIELD OF THE INVENTION

This invention relates generally to indicators, and more specifically to methods and apparatuses for a segmented progress indicator.

### BACKGROUND

Progress indicators, such as progress bars, are components of user interfaces (such as graphical user interfaces) utilized to indicate the progress of an operation. Such operations may include, but are not limited to, operations such as a download or a file transfer. Progress bars are typically presented as a rectangle which is filled in to indicate a total amount of progress of the operation. As the operation progresses, more of the rectangle is filled in. Progress bars may be accompanied by a textual representation of the progress, typically in a percent format.

### SUMMARY

An operation is determined to include at least two steps. The at least two steps may require different times for completion. A segmented progress indicator displays the progress for the operation by displaying a separate section for each step wherein each section displays the progress of the respective individual step. The of each section or step may be displayed at an approximately even and/or constant rate, unlike if the segmented progress indicator only displayed the progress of the entire operation. Thus, the progress indicated by the segmented progress indicator may not appear erratic and/or random to a user.

In order to determine the progress for each step to display in the respective section, the percentage of the amount of work a step has performed in relation to the total amount of work the step will perform may be determined. Various means may be utilized to make this determination. This determined percentage may then be visually expressed in the respective section as the percentage of the respective section that is filled. The percentage of the respective section that is filled may be visually expressed by indicating a portion of the respective section with a first indicator. The percentage of the respective section that is not filled may be visually expressed by indicating a portion of the respective section with a second indicator.

One or more of the steps in the operation may encounter an error during performance. The occurrence of the error may be indicated in the respective section. Thus, the user may be able to derive more information about the error than if the progress of the individual steps were not displayed and may be better able to address the error or provide more information to support personnel such as a technical support call center.

A system that may be operable to display the segmented progress indicator may comprise a processing device which is communicably connected to a display. The processing device may include a processing unit operable to determine the number of steps in the operation and the progress of each of the steps in the operation. The display may be operable to display the segmented progress indicator, indicating the progress of the steps of the operation. In some embodiments, the display may be incorporated within the processing device.

The steps of the operation may be linear, non-linear, or a mixture of linear and non-linear. As such, the progress of individual steps included in an operation may be displayed in a linear sequence, a non-linear sequence, and/or a mixture of linear sequences and non-linear sequences in a segmented progress indicator.

The sections of a segmented progress indicator may have similar dimensions. Alternatively, the sections of a segmented progress indicator may have dissimilar dimensions. Sections of a segmented progress indicator may have a relationship between their respective dimensions which is proportional to the times (or estimated times) for completion of the respective corresponding steps.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The present disclosure may be better understood, and its numerous features made apparent to those skilled in the art by referencing the accompanying drawings.

FIGS. 1a-1e are diagrams illustrating a segmented progress bar 100, in accordance with an embodiment of the present disclosure;

FIGS. 2a-2b are block diagrams illustrating example systems 200a and 200b for displaying the segmented progress bar 100 of FIGS. 1a-1e, in accordance with an embodiment of the present disclosure;

FIGS. 3a-3c are diagrams illustrating a segmented progress bar 300, in accordance with a first alternative embodiment of the present disclosure;

FIG. 4 is a block diagram illustrating a system 400 for displaying the segmented progress bar 300 of FIGS. 3a-3c, in accordance with the first alternative embodiment of the present disclosure;

FIG. 5 is a method diagram illustrating a method 500 for displaying a segmented progress indicator, in accordance with an embodiment of the present disclosure;

FIG. 6 is a method diagram illustrating a method 600 for displaying a segmented progress indicator, in accordance with a second alternative embodiment of the present disclosure;

FIG. 7 is a method diagram illustrating a method 700 for displaying a segmented progress indicator, in accordance with a third alternative embodiment of the present disclosure;

FIG. 8 is a method diagram illustrating a method 800 for displaying a segmented progress indicator, in accordance with a fourth alternative embodiment of the present disclosure; and

FIG. 9 is a method diagram illustrating a method 900 for displaying a segmented progress indicator, in accordance with a fifth alternative embodiment of the present disclosure.

### DETAILED DESCRIPTION OF THE EMBODIMENTS

The description that follows includes exemplary systems, methods, techniques, instruction sequences, and/or computer program products that embody techniques of the present disclosure. However, it is understood that the described disclosure may be practiced without these specific details. Reference will now be made in detail to the subject matter disclosed, which is illustrated in the accompanying drawings.

Progress indicators may be typically utilized when a user may need and/or want to know the progress of an operation. For example, when a user downloads and installs an update for his personal computer, the user may want to know the progress so that he knows when he will be able to utilize his personal computer for other tasks such as electronic mail, word processing, and/or Internet browsing. However, the progress of operations indicated by progress indicators may appear random to users. For a variety of reasons (such as delays in performing an operation and/or uncertainty in determining the amount of time an operation will take to complete), progress indicators may appear to indicate the progress of the operation erratically. To the user, the progress indicator may appear to stop, start, and/or jump forward without reason. As a result, users may be uncertain as to the progress of the operation and/or the remaining amount of time that the operation will take, despite viewing the progress indicator.

Progress indicators may attempt to present a less random indication to the user by displaying an estimated time until completion. However, completion times may be unpredictable and/or delays may occur and the estimated time may be revised during the progress of the operation. Thus, the progress indicator may appear no less random than if an estimated time until completion were not displayed. Indeterminate progress bars typically utilize motion or some other indicator to show that progress is taking place rather than utilizing a size of a filled portion to show the total amount of progress. However, indeterminate progress bars are more like throbbers (animated graphics) in that they practically indicate that an operation is being performed rather than indicating how an operation is progressing. Intermediate progress bars may not provide any better indication as to the progress of an operation than standard progress bars or other progress indicators that display an estimated time until completion.

One reason progress indicators may appear random and erratic to users is that the operation whose progress is indicated may comprise a number of steps (or sub-operations) which may each require a different period of time for completion. The progress indicator, which indicates the progress of the entire operation, may display the progress at varying rates as individual the individual steps (which may each require a different period of time) complete. As a result, the indicated progress may appear erratic and random.

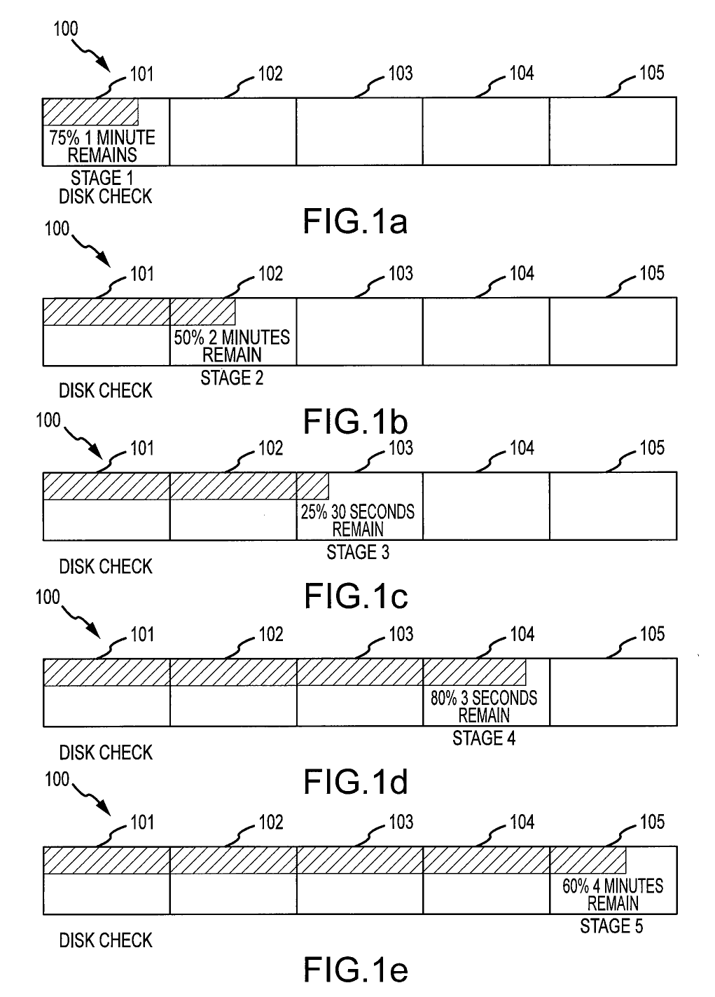

FIGS. 1a-1e illustrate a segmented progress bar 100 (which may be created by software executed by hardware such as a processing unit and displayed utilizing a hardware device such as a display), in accordance with an embodiment of the present disclosure. The segmented progress bar 100 indicates the progress of a Linux ext3 (third extended file system) file system disk check operation. Although the present example relates to the progress of a Linux ext3 file system disk check operation, it is understood that a segmented progress indicator may indicate the progress of any operation without departing from the scope of the present disclosure. Though the segmented progress bar 100 indicates the progress of the entire disk check operation, the operation is determined (utilizing hardware such as a processing unit) to comprise five separate steps and the segmented progress bar 100 displays a separate section 101-105 for each step (though the separate sections 101-105 comprise the single image of the segmented progress bar 100). As each section 101-105 displays the progress of an individual step, the display of the progress of each section 101-105 may be displayed at an approximately even rate (with respect to that section), unlike if the segmented progress bar 100 only displayed the progress of the entire disk check operation. The progress of an individual step may be displayed at a constant rate in the respective section 101-105 (with respect to that section) of the segmented progress bar 100. Thus, the progress indicated by the segmented progress bar 100 may not appear erratic and/or random to a user.

A disk check operation for a Linux ext3 file system is an operation which checks the consistency of the file system. The operation may include five stages. Stage one may comprise checking blocks and sizes. Stage two may comprise checking pathnames. Stage three may comprise checking connectivity. Stage four may comprise checking reference counts. Stage five may comprise checking cylinder groups. For the purposes of example, stages one and two are illustrated as requiring four minutes for completion, stage three is illustrated as requiring forty seconds for completion, stage four is illustrated as requiring fifteen seconds for completion, and stage five is illustrated as requiring ten minutes for completion. However, it should be understood that the five stages of a disk check operation for a Linux ext3 file system and/or the operation itself may require other amounts of time for completion than those illustrated in this example.

In order to determine the progress for each step to display in the respective section 101-105, the percentage of the amount of work a step has performed in relation to the total amount of work the step will perform may be determined (such as by hardware including, but not limited to, a processing unit). Various means may be utilized to make this determination. For example, checkpoints may be utilized to monitor the amount of work a step has performed in relation to the total amount of work the step will perform. This determined percentage may then be visually expressed in the respective section 101-105 as the percentage of the respective section 101-105 that is filled. The percentage of the respective section 101-105 that is filled may be visually expressed by indicating a portion of the respective section 101-105 with a first indicator (such as a first color including, but not limited to, blue). The percentage of the respective section 101-105 that is not filled (or empty) may be visually expressed by indicating a portion of the respective section 101-105 with a second indicator (such as a second color including, but not limited to, white and/or grey).

FIGS. 1a-1e illustrate the segmented progress bar 100 at a series of stages during the progress of the disk check operation. In FIG. 1a, section 101 indicates that stage one is approximately seventy-five percent complete. Additionally, a textual description is displayed stating that stage one is being performed, that stage one is seventy-five percent complete, and that an estimated one minute remains before stage one will complete. In FIG. 1b, section 101 indicates that stage one is complete. Section 102 indicates that stage two is approximately fifty percent complete. Additionally, a textual description is displayed stating that stage two is being performed, that stage two is fifty percent complete, and that an estimated two minutes remain before stage two will complete. In FIG. 1c, section 101 indicates that stage one is complete and section 102 indicates that stage two is complete. Section 103 indicates that stage three is approximately twenty-five percent complete. Additionally, a textual description is displayed stating that stage three is being performed, that stage three is twenty-five percent complete, and that an estimated thirty seconds remain before stage three will complete. In FIG. 1d, section 101 indicates that stage one is complete, section 102 indicates that stage two is complete, and section 103 indicates that stage three is complete. Section 104 indicates that stage four is approximately eighty percent complete. Additionally, a textual description is displayed stating that stage four is being performed, that stage four is eighty percent complete, and that an estimated three seconds remain before stage four will complete. In FIG. 1e, section 101 indicates that stage one is complete, section 102 indicates that stage two is complete, section 103 indicates that stage three is complete, and section 104 indicates that stage four is complete. Section 105 indicates that stage five is approximately sixty percent complete. Additionally, a textual description is displayed stating that stage five is being performed, that stage five is sixty percent complete, and that an estimated four minutes remain before stage five will complete.

One or more of the steps in the disk check operation (or other operation for which a segmented progress indicator is utilized) may encounter an error during performance. The error may prevent the one or more steps from completing. The occurrence of the error may be indicated in the respective section 101-105. For example, an error may be indicated in the performance of a step by displaying that the progress has halted. This may be displayed by the indicated progress not progressing, or freezing. If the progress indicated in a section 101-105 does not continue to progress, a user may be able to determine the step that has encountered an error. Thus, the user may be able to derive more information about the error than if the progress of the individual steps were not displayed and may be better able to address the error or provide more information to support personnel such as a technical support call center.

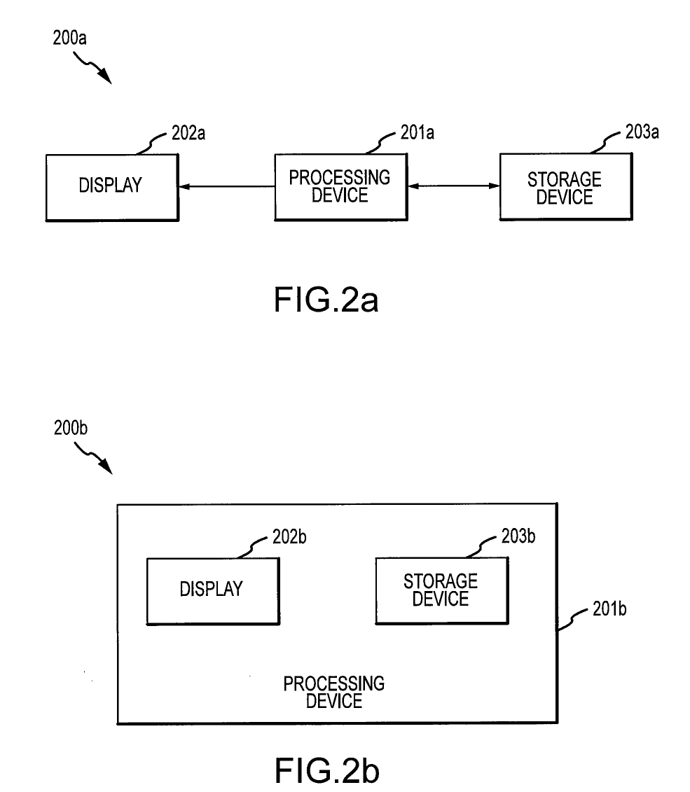

FIGS. 2a and 2b illustrate example systems 200a and 200b for displaying the segmented progress bar 100 of FIGS. 1a-1e, in accordance with an embodiment of the present disclosure. The system 200a is an example of a system that may be operable to display the segmented progress bar 100 of FIGS. 1a-1e. The system 200a may comprise a processing device 201a which is communicably connected to a display 202a and a storage device 203a. The disk check operation may be performed upon the storage device 203a (which may include a storage media that utilizes the Linux ext3 file system) by the processing device 201a. The processing device 201a may include a processing unit operable to determine the number of steps in the disk check operation and the progress of each of the steps in the disk check operation. The processing device 201a may be operable to output the segmented progress bar 100 to the display 202a. The display 202a may be operable to display the segmented progress bar 100, indicating the progress of the steps of the disk check operation. By way of example, the processing device 201a may comprise a set-top box (a device that connects to a television and an external source of signal, such as a satellite and/or cable television signal, converting the signal into content that is displayed on the television), the display 202a may comprise a television, and the storage device 203a may comprise an external hard drive.

The system 200b is another example of a system that may be operable to display the segmented progress bar 100 of FIGS. 1a-1e. The system 200b may comprise a processing device 201b which may include a display 202b and a storage device 203b. The display 202b and the storage device 203b may be incorporated within processing device 201b. The system 200b may comprise a laptop computer or other computing device incorporating a display, processing unit, and storage into a single unit. The disk check operation may be performed upon the storage device 203b (which may include a storage media that utilizes the Linux ext3 file system) by the processing device 201b. The processing device 201b may include a processing unit operable to determine the number of steps in the disk check operation and the progress of each of the steps in the disk check operation. The display 202b may be operable to display the segmented progress bar 100, indicating the progress of the steps of the disk check operation.

The five stages of a disk check operation for a Linux ext3 file system may be linear. Thus, stage one may need to finish prior to the start of stage two. As such, the progress of stages two through five, depicted in sections 102-105 respectively, may be displayed after the completion of the previous stage (indicated in the respective section 101-104). However, it should be understood that the progress of individual steps included in an operation may not necessarily be displayed in a linear sequence in a segmented progress indicator. If one or more such steps of an operation may be performed in a non-linear fashion the progress of the non-linearly performed steps may be indicated in one or more sections of a segmented progress indicator in a non-linear fashion.

The sections 101-105 in FIGS. 1a-1e are illustrated as having approximately equal dimensions. It should be understood that sections of a segmented progress indicator may have dissimilar dimensions. Sections of a segmented progress indicator may have a relationship between their respective dimensions which is proportional to the times (or estimated times) for completion of the respective corresponding steps.

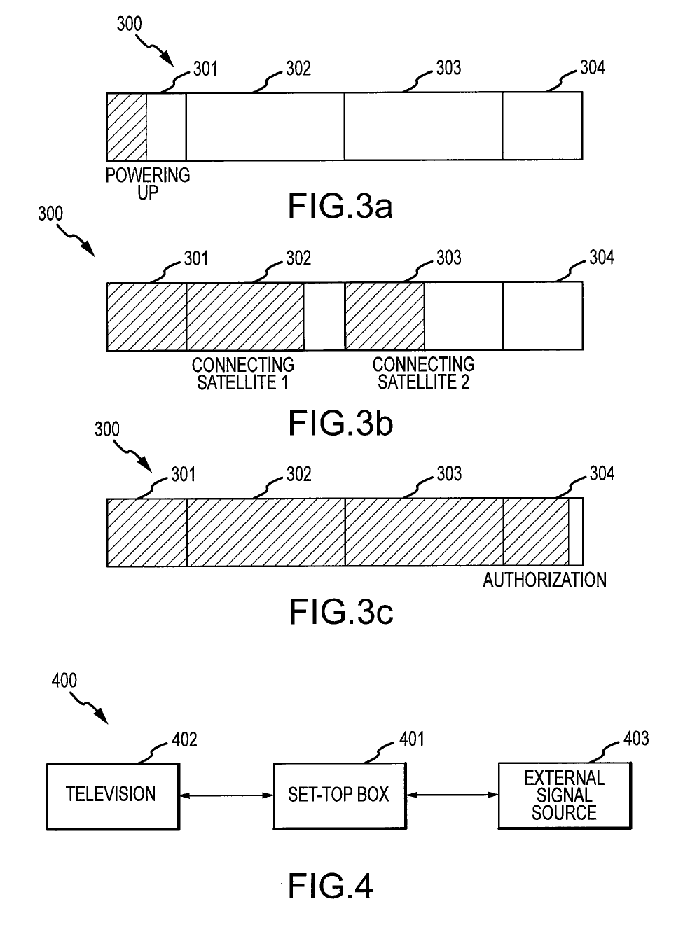

FIGS. 3a-3c illustrate a segmented progress bar 300, in accordance with a first alternative embodiment of the present disclosure. The segmented progress bar 300 indicates the progress of a start-up operation for a set-top box (or set-top unit), such as the DISH Player—DVR 942 marketed by DISH Network®, a registered trademark of DISH Network L.L.C. In this example, the set-top box comprises a dual-mode satellite receiver. Though the segmented progress bar 300 indicates the progress of the entire start-up operation for the set-top box, the operation is determined to comprise four separate steps and the segmented progress bar 300 displays a separate section 301-304 for each step (the separate sections 301-304 comprise the single image of the segmented progress bar 300).

The start-up operation for the set-top box may be an operation that prepares the set-top box for utilization by a user. This operation may include four steps. Step one may comprise powering up the set-top box. Powering up the set-top box may include a self-test designed to ensure that the components of the set-top box are operating properly. Powering up the set-top box may also include initializing the set-top box so that it is prepared for operation. Step two may comprise connecting to a first satellite. Step three may comprise connecting to a second satellite. Step four may comprise authorization. Authorization may comprise determining that the set-top box is authorized to receive content, determining that the user of the set-top box is authorized to receive content, and/or determining the content that the set-top box and/or user are authorized to receive. It is understood that this start-up operation is an example. A set-top box may utilize a different start-up operation (which may include different steps and/or different numbers of steps) without departing from the scope of this disclosure.

In order to determine the progress for each step to display in the respective section 301-304, the percentage of the amount of work a step has performed in relation to the total amount of work the step will perform may be determined. Various means may be utilized to make this determination. For example, the amount of work a step has performed in relation to the total amount of work the step will perform may be determined by analyzing whether one or more specific tasks that the step will perform have been performed. This determined percentage may then be visually expressed in the respective section 301-304 as the percentage of the respective section 301-304 that is filled. The percentage of the respective section 301-304 that is filled may be visually expressed by indicating a portion of the respective section 301-304 with a first indicator (such as a first color including, but not limited to, red and/or green). The percentage of the respective section 301-304 that is not filled (or empty) may be visually expressed by indicating a portion of the respective section 301-304 with a second indicator (such as a second color including, but not limited to, black and/or grey).

FIGS. 3a-3c illustrate the segmented progress bar 300 at a series of stages during the progress of the start-up operation. In FIG. 3a, section 101 indicates that powering up is approximately fifty percent complete. Additionally, a textual description is displayed stating that powering up is being performed. In FIG. 3b, section 301 indicates that powering up is complete. Section 302 indicates that connecting to the first satellite is approximately seventy-five percent complete and section 303 indicates that connecting to the second satellite is fifty percent complete. Additionally, a textual description is displayed stating that connecting to the first satellite and connecting to the second satellite are being performed. In FIG. 3c, section 301 indicates that powering up is complete, section 302 indicates that connecting to the first satellite is complete, and section 303 indicates that connecting to the second satellite is complete. Section 304 indicates that authorization is approximately eighty percent complete. Additionally, a textual description is displayed stating that authorization is being performed.

One or more of the steps in the start-up operation may encounter an error during performance. The error may prevent the one or more steps from completing. The occurrence of the error may be indicated in the respective section 301-304. For example, an error may be indicated in the performance of a step by displaying that the progress has halted. This may be displayed by the indicated progress not progressing, or freezing. If the progress indicated in a section 301-304 does not continue to progress, a user may be able to determine the step that has encountered an error. Thus, the user may be able to derive more information about the error than if the progress of the individual steps were not displayed and may be better able to address the error or provide more information to support personnel such as a technical support call center.

FIG. 4 illustrates an example system 400 for displaying the segmented progress bar 300 of FIGS. 3a-3c, in accordance with the first alternative embodiment of the present disclosure. The system 400 is an example of a system that may be operable to display the segmented progress bar 300 of FIGS. 3a-3c. The system 400 may comprise a set-top box 401 which is communicably connected to a television 402 and a external signal source 403. The set-top box 401 may include a processing unit operable to determine the number of steps in the start-up operation and the progress of each of the steps in the start-up operation. The television 402 and/or the set-top box may be operable to display the segmented progress bar 300, indicating the progress of the steps of the start-up operation. It is understood that the system 400 is an example of a system for displaying the segmented progress bar 300. Other systems (such as a system where the set-top box 401 and the television 402 are integrated into a single unit) may be utilized to display the segmented progress bar 300 without departing from the scope of the present disclosure.

The powering up and authorization steps of the start-up operation for the set-top box may be linear. Thus, powering up may need to finish prior to the start of connecting to the first satellite and connecting to the second satellite and connecting to the first satellite and connecting to the second satellite may need to finish prior to the start of authorization. As such, the progress of connecting to the first satellite and connecting to the second satellite, depicted in sections 302 and 303 respectively, may be displayed after the completion of powering up (indicated in section 301). Also, the progress of authorization, depicted in section 304, may be displayed after the completion of connecting to the first satellite and connecting to the second satellite (indicated respectively in sections 302 and 303). However, it should be understood that the progress of individual steps included in an operation may be displayed in a linear sequence in a segmented progress indicator. For example, connecting to the first satellite may not need to finish prior to connecting to the second satellite. As such, the progress of connecting to the first satellite and connecting to the second satellite, depicted in sections 302 and 303 respectively, may be displayed approximately simultaneously. Further, although the present example has been illustrated and described displaying the progress of individual steps in both linear sequences and non-linear sequences, it should be understood that the progress of individual steps included in an operation may be displayed in a linear sequence, a non-linear sequence, and/or a mixture of linear sequences and non-linear sequences in a segmented progress indicator.

The sections 301-304 in FIGS. 3a-3c are illustrated as having unequal dimensions. As illustrated, sections 302 and 303 are approximately equal to each other but are approximately twice the length of sections 301 and 304. As such, sections 302 and 303 may indicate that connecting to satellite one and connecting to satellite two require twice the time (or estimated time) for completion as powering up and authorization.

Although the present disclosure has been described in one example with respect to a five section segmented progress bar indicating the progress of the stages of a five step disk check and another example with respect to a four section segmented progress bar indicating the progress of the steps of a four step start-up sequence, it is understood that the segmented progress indicator of the present disclosure is not limited to any particular operation, any particular device, any particular number of steps and/or stages, any particular graphical representation of the segmented progress indicator, and/or any particular number of sections. Other operations, devices, number of stages and/or steps, graphical representations, and/or number of sections may be utilized without departing from the scope of the present disclosure. The operation may include no more than approximately ten steps as presenting a segmented progress indicator with many more than ten segments may be visually confusing to users.

Further, although the present disclosure has been described with respect to a segmented progress bar, it is understood that any segmented progress indicator may be utilized without departing from the scope of the present application. For example, a segmented progress indicator may comprise a pie chart wherein sections of the pie chart indicate the progress of one or more steps in an operation.

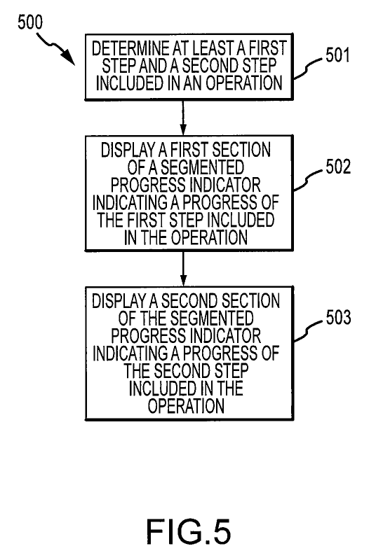

FIG. 5 is a method diagram illustrating a method 500 for displaying a segmented progress indicator, in accordance with an embodiment of the present disclosure. In operation 501, the embodiment determines at least a first step and a second step included in an operation. The operation may include no more than approximately ten steps. In operation 502, the embodiment displays a first section of a segmented progress indicator indicating a progress of the first step included in the operation. Displaying a first section of a segmented progress indicator indicating a progress of the first step included in the operation may comprise determining a percent completed of the first step and indicating the percent completed of the first step in the first section. Indicating the percent completed of the first step in the first section may comprise filling a first portion of an area of the first section, corresponding to the percent completed of the first step, with a first indicator and filling a second portion of the area of the first section, corresponding to a percent uncompleted of the first step, with a second indicator. Displaying a first section of a segmented progress indicator indicating a progress of the first step included in the operation may comprise displaying the first section of the segmented progress indicator indicating a progress of the first step at a constant speed.

In operation 503, the embodiment displays a second section of the segmented progress indicator indicating a progress of the second step included in the operation. The segmented progress indicator including the first section and the second section comprise a single image. Displaying a second section of a segmented progress indicator indicating a progress of the second step included in the operation may comprise determining a percent completed of the second step and indicating the percent completed of the second step in the second section. Indicating the percent completed of the second step in the second section may comprise filling a first portion of an area of the second section, corresponding to the percent completed of the second step, with a first indicator and filling a second portion of the area of the second section, corresponding to a percent uncompleted of the second step, with a second indicator. Displaying a second section of a segmented progress indicator indicating a progress of the second step included in the operation may comprise displaying the second section of the segmented progress indicator indicating a progress of the second step at a constant speed. The second section of the segmented progress indicator indicating the progress of the second step may be displayed subsequent to the completion of the first step or previous to the completion of the first step. A dimension of the second section of the segmented progress indicator may exceed a dimension of the first section of the segmented progress indicator. A relationship between a dimension of the second section of the segmented progress indicator and a dimension of the first section of the segmented progress indicator may be proportional to a relationship between a time (and/or estimated time) for completion of the second step and a time (and/or estimated time) for completion of the first step. A dimension of the second section of the segmented progress indicator may be approximately equal to a dimension of the first section of the segmented progress indicator. The first step may have a first time required for completion, the second step may have a second time required for completion, and the first time and second time may not be equal.

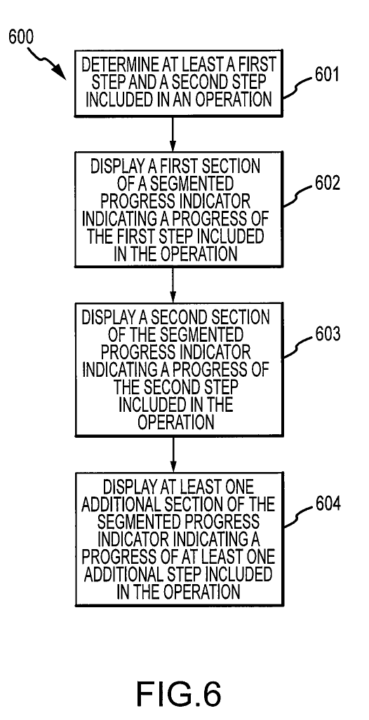

FIG. 6 is a method diagram illustrating a method 600 for displaying a segmented progress indicator, in accordance with a second alternative embodiment of the present disclosure. In operation 601, the embodiment determines at least a first step and a second step included in an operation. In operation 602, the embodiment displays a first section of a segmented progress indicator indicating a progress of the first step included in the operation. In operation 603, the embodiment displays a second section of the segmented progress indicator indicating a progress of the second step included in the operation. The segmented progress indicator including the first section and the second section comprise a single image. In operation 604, the embodiment displays at least one additional section of the segmented progress indicator indicating a progress of at least one additional step included in the operation.

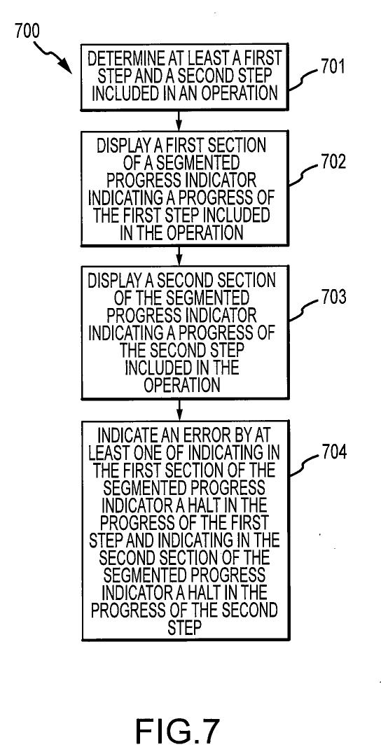

FIG. 7 is a method diagram illustrating a method 700 for displaying a segmented progress indicator, in accordance with a third alternative embodiment of the present disclosure. In operation 701, the embodiment determines at least a first step and a second step included in an operation. In operation 702, the embodiment displays a first section of a segmented progress indicator indicating a progress of the first step included in the operation. In operation 703, the embodiment displays a second section of the segmented progress indicator indicating a progress of the second step included in the operation. The segmented progress indicator including the first section and the second section comprise a single image. In operation 704, the embodiment indicates an error by at least one of indicating in the first section of the segmented progress indicator a halt in the progress of the first step and indicating in the second section of the segmented progress indicator a halt in the progress of the second step.

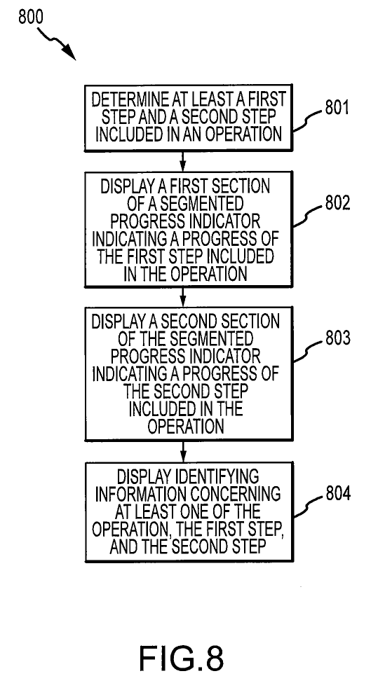

FIG. 8 is a method diagram illustrating a method 800 for displaying a segmented progress indicator, in accordance with a fourth alternative embodiment of the present disclosure. In operation 801, the embodiment determines at least a first step and a second step included in an operation. In operation 802, the embodiment displays a first section of a segmented progress indicator indicating a progress of the first step included in the operation. In operation 803, the embodiment displays a second section of the segmented progress indicator indicating a progress of the second step included in the operation. The segmented progress indicator including the first section and the second section comprise a single image. In operation 804, the embodiment displays identifying information concerning at least one of the operation, the first step, and the second step.

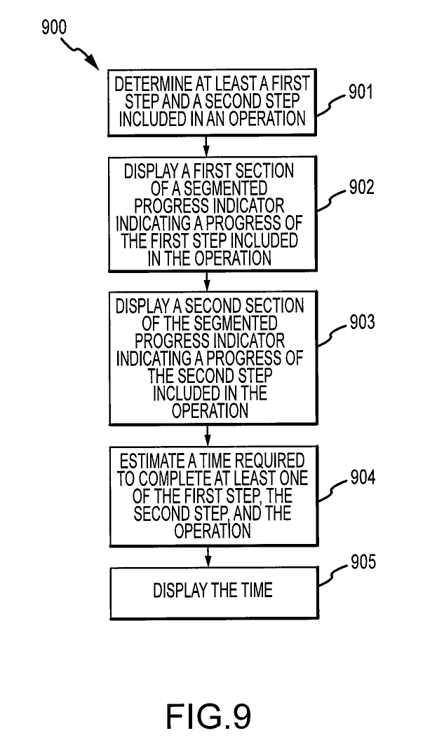

FIG. 9 is a method diagram illustrating a method 900 for displaying a segmented progress indicator, in accordance with a fifth alternative embodiment of the present disclosure. In operation 901, the embodiment determines at least a first step and a second step included in an operation. In operation 902, the embodiment displays a first section of a segmented progress indicator indicating a progress of the first step included in the operation. In operation 903, the embodiment displays a second section of the segmented progress indicator indicating a progress of the second step included in the operation. The segmented progress indicator including the first section and the second section comprise a single image. In operation 904, the embodiment estimates a time required to complete at least one of the first step, the second step, and the operation. In operation 905, the embodiment displays the time.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readably by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

1. A method, comprising:
determining at least a first step and a second step included in an operation;
displaying a first section of a segmented progress indicator indicating a progress of the first step included in the operation; and
displaying a second section of the segmented progress indicator indicating a progress of the second step included in the operation, the segmented progress indicator including the first section and the second section comprising a single image.

2. The method of claim 1, wherein said displaying a first section of a segmented progress indicator indicating a progress of the first step included in the operation further comprises:
determining a percent completed of the first step; and
indicating the percent completed of the first step in the first section.

3. The method of claim 2, wherein said indicating the percent completed of the first step in the first section comprises:
filling a first portion of an area of the first section, corresponding to the percent completed of the first step, with a first indicator, and
filling a second portion of the area of the first section, corresponding to a percent uncompleted of the first step, with a second indicator.

4. The method of claim 1, wherein said displaying a second section of the segmented progress indicator indicating a progress of the second step included in the operation further comprises:
determining a percent completed of the second step; and
indicating the percent completed of the second step in the second section.

5. The method of claim 4, wherein said indicating the percent completed of the first step in the first section comprises:
filling a first portion of an area of the second section, corresponding to the percent completed of the second step, with a first indicator, and
filling a second portion of the area of the second section, corresponding to a percent uncompleted of the second step, with a second indicator.

6. The method of claim 1, wherein said displaying a first section of a segmented progress indicator indicating a progress of the first step included in the operation further comprises:
displaying the first section of the segmented progress indicator indicating a progress of the first step at a constant speed with respect to the first section.

7. The method of claim 1, wherein said displaying a second section of the segmented progress indicator indicating a progress of the second step included in the operation further comprises:
displaying the second section of the segmented progress indicator indicating the progress of the second step at a constant speed with respect to the second section.

8. The method of claim 1, wherein a dimension of the second section of the segmented progress indicator exceeds a dimension of the first section of the segmented progress indicator.

9. The method of claim 8, wherein a relationship between the dimension of the second section of the segmented progress indicator and the dimension of the first section of the segmented progress indicator is proportional to a relationship between an estimated time for completion of the second step and an estimated time for completion of the first step.

10. The method of claim 1, wherein a dimension of the second section of the segmented progress indicator is the same as a dimension of the first section of the segmented progress indicator.

11. The method of claim 1, wherein said displaying a second section of the segmented progress indicator indicating a progress of the second step included in the operation further comprises:
displaying the second section of the segmented progress indicator indicating the progress of the second step subsequent to completion of the first step.

12. The method of claim 1, wherein said displaying a second section of the segmented progress indicator indicating a progress of the second step included in the operation further comprises:
displaying the second section of the segmented progress indicator indicating the progress of the second step previous to completion of the first step.

13. The method of claim 1, further comprising:
displaying at least one additional section of the segmented progress indicator indicating a progress of at least one additional step included in the operation.

14. The method of claim 1, further comprising:
indicating an error by at least one of indicating in the first section of the segmented progress indicator a halt in the progress of the first step and indicating in the second section of the segmented progress indicator a halt in the progress of the second step.

15. The method of claim 1, wherein the first step has a first time required for completion, the second step has a second time required for completion, and the first time and second time are not equal.

16. The method of claim 1, further comprising:
displaying identifying information concerning at least one of the operation, the first step, and the second step.

17. The method of claim 1, wherein the operation includes no more than approximately ten steps.

18. The method of claim 1, further comprising:
estimating a time required to complete at least one of the first step, the second step, and the operation, and
displaying the time.

19. A computer program product, including a computer readable storage medium and instructions executable by a processing unit tangibly embodied in the computer readable storage medium, the instructions comprising:
a first set of instructions for determining at least a first step and a second step included in an operation;
a second set of instructions for displaying a first section of a segmented progress indicator indicating a progress of the first step included in the operation; and
a third set of instructions for displaying a second section of the segmented progress indicator indicating a progress of the second step included in the operation, the segmented progress indicator including the first section and the second section comprising a single image.

20. A system, comprising:
a processing unit operable to determine at least a first step a second step included in an operation, a progress of the first step, and a progress of the second step; and
a display, communicably connected to the processing unit, operable to display a segmented progress indicator including at least a first section and a second section comprising a single image;
wherein the first section indicates the progress of the first step at a constant rate with respect to the first section the second section indicates a progress of the second step at a constant rate with respect to the second section.
